(19) United States
(12) Patent Application Publication
(10) Pub. No.: US 2005/0267244 A1
(43) Pub. Date: Dec. 1, 2005

(54) Method of preparing of tube shoulder having barrier properties

(76) Inventors: Myung Ho Kim, Daejeon-city (KR); Minki Kim, Daejeon-city (KR); Youngchul Yang, Daejeon-city (KR); Jaeyong Shin, Daejeon-city (KR)

Correspondence Address: CANTOR COLBURN, LLP, 55 GRIFFIN ROAD SOUTH, BLOOMFIELD, CT, 06002, US

(21) Appl. No.: 11/132,622

(22) Filed: May 19, 2005

(30) Foreign Application Priority Data
May 27, 2004 (KR) 10-2004-0037693
Apr. 8, 2005 (KR) 10-2005-0029579

(51) Int. Cl. C08K 3/34

(52) U.S. Cl. 524/445

(57) ABSTRACT

A method of preparing a tube shoulder having barrier properties is provided. The method includes: dry-blending a polyolefin resin and a resin having barrier properties/intercalated clay nanocomposite to form a nanocomposite composition and then molten-blending, pelletizing and molding the nanocomposite composition. A tube shoulder prepared according the method has superior barrier properties and adhesion to a tube body, and thus can effectively prevent the inflow of oxygen, thereby preventing decomposition of contents.

### CROSS-REFERENCE TO RELATED PATENT APPLICATION

This application claims the benefit of Korean Patent Application No. 10-2004-0037693, filed on May 27, 2004 and Korean Patent Application No. 10-2005-0029579, filed on Apr. 8, 2005, in the Korean Intellectual Property Office, the disclosures of which are incorporated herein in their entirety by reference.

### BACKGROUND OF THE INVENTION

1. Field of the Invention

The present invention relates to a method of preparing a tube shoulder having good barrier properties and adhesion to a tube body by dry-blending a polyolefin resin, a nanocomposite of an intercalated clay and a resin having barrier properties and a compatibilizer to prepare a nanocomposite composition and then molten-blending, pelletizing and molding the nanocomposite composition.

2. Description of the Related Art

Metal cans, glass bottles and various plastic containers are used as packaging containers. However, these packaging containers have problems in that their contents decompose and lose flavor of the contents due to oxygen remaining therein and the inflow of oxygen through a container wall. In the case of metal cans and glass bottles, only oxygen remained therein causes trouble and the inflow of oxygen does not occur. However, in the case of plastic containers, the decomposition of contents is caused due to large inflow of oxygen, and thus, their use as packaging containers is limited even though they are light, are not brittle and are easily molded.

To solve these problems, plastic containers having a wall composed of a multi-layered structure including a resin layer having barrier properties such as an ethylene-vinyl alcohol (EVOH) copolymer have been used. The most representative example is a container having a five-layered structure of LDPE/adhesive/EVOH/adhesive/LDPE.

However, in tube-type containers, while a tube body can be molded into the multi-layered structure having superior barrier properties, a tube shoulder having a neck cannot be molded into the multi-layered structure due to a complicated shape. Thus, the tube shoulder is molded using a single-layered polyolefin etc. and then bonded to the tube body.

In this case, the tube shoulder does not have barrier properties, and thus preservation of products is difficult due to inflow of oxygen through the tube shoulder in containers for packaging toothpaste or cosmetics.

### SUMMARY OF THE INVENTION

The present invention provides a method of preparing a tube shoulder having good barrier properties and adhesion to a tube body by dry-blending a polyolefin resin, a resin having barrier properties/intercalated clay nanocomposite and a compatibilizer to form a nanocomposite composition and then molten-blending, pelletizing and molding the nanocomposite composition.

According to an aspect of the present invention, there is provided a method of preparing a tube shoulder having barrier properties, the method including: mixing an intercalated clay and at least one resin having barrier properties, selected from the group consisting of an ethylene-vinyl alcohol (EVOH) copolymer, a polyamide, an ionomer and a polyvinyl alcohol (PVA) to prepare a nanocomposite having barrier properties; dry-blending the nanocomposite with a polyolefin resin and a compatibilizer to prepare a nanocomposite composition; molten-blending the nanocomposite composition in an extruder to form a pellet having barrier properties; and molding the pellet.

When preparing the nanocomposite composition, 1 to 95 parts by weight of the nanocomposite, 1 to 97 parts by weight of the polyolefin resin and 1 to 95 parts by weight of the compatibilizer may be blended.

The nanocomposite composition is molten-blended in an extruder with a L/D ratio of the extruder of 20 or less at 160 to 270° C. to form a pellet.

### DETAILED DESCRIPTION OF THE INVENTION

The present invention will now be described in more detail.

In the present invention, a nanocomposite composition may be prepared and formed in a pellet form before preparing a tube shoulder.

First, a process of preparing the nanocomposite composition will be described.

In the present invention, an intercalated clay is mixed with at least one resin having barrier properties, selected from the group consisting of an ethylene-vinyl alcohol (EVOH) copolymer, a polyamide, an ionomer and a polyvinyl alcohol (PVA) to prepare a nanocomposite having barrier properties. Then, the nanocomposite is dry-blended with a polyolefin resin and a compatibilizer to prepare a nanocomposite composition.

The weight ratio of the resin having barrier properties to the intercalated clay in the nanocomposite is 58.0:42.0 to 99.9:0.1, and preferably 85.0:15.0 to 99.0:1.0. If the weight ratio of the resin having barrier properties to the intercalated clay is less than 58.0:42.0, the intercalated clay agglomerates and dispersing is difficult. If the weight ratio of the resin having barrier properties to the intercalated clay is greater than 99.9:0.1, the improvement in the barrier properties is negligible.

The intercalated clay is preferably organic intercalated clay. The content of an organic material in the intercalated clay is preferably 1 to 45 wt %. When the content of the organic material is less than 1 wt %, the compatibility of the intercalated clay and the resin having barrier properties is poor. When the content of the organic material is greater than 45 wt %, the intercalation of the resin having barrier properties is difficult.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from quaternary ammonium, phosphonium, maleate, succinate, acrylate, benzylic hydrogen, and oxazoline.

If an ethylene-vinyl alcohol (EVOH) copolymer is included in the nanocomposite, the content of ethylene in the ethylene-vinyl alcohol copolymer is preferably 10 to 50 mol %. If the content of ethylene is less than 10 mol %, melt molding becomes difficult due to poor processability. If the content of ethylene exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

The amorphous polyamide refers to a polyamide having insufficient crystallinity, that is, not having an endothermic crystalline melting peak when measured by a differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylenediamine, 1,5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using aliphatic diamine and aliphatic dicarboxylic acid is general semicrystalline polyamide (also referred to as crystalline nylon) and is not amorphous polyamide. Polyamide prepared using aromatic diamine and aromatic dicarboxylic acid is not easily treated using a general melting process.

Thus, amorphous polyamide is preferably prepared, when one of diamine and dicarboxylic acid used is aromatic and the other is aliphatic. Aliphatic groups of the amorphous polyamide are preferably C₁-C₁₅ aliphatic or C₄-C₈ alicyclic alkyls. Aromatic groups of the amorphous polyamide are preferably substituted C₁-C₆ mono- or bicyclic aromatic groups. However, all the above amorphous polyamide is not preferable in the present invention. For example, metaxylenediamine adipamide is easily crystallized when heated during a thermal molding process or when oriented, therefore, it is not preferable.

Examples of preferable amorphous polyamides include hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, a copolymer of hexamethylenediamine or 2-methylpentamethylenediamine and an isophthalic acid, terephthalic acid or mixtures thereof. While polyamide based on hexamethylenediamine isophthalamide/terephthalamide, which has a high terephthalic acid content, is useful, it should be mixed with another diamine such as 2-methyldiaminopentane in order to produce an amorphous polyamide that can be processed.

The above amorphous polyamide comprising only the above monomers may contain a small amount of lactam, such as caprolactam or lauryl lactam, as a comonomer. It is important that the polyamide be amorphous. Therefore, any comonomer that does not crystallize polyamide can be used. About 10 wt % or less of a liquid or solid plasticizer, such as glycerole, sorbitol, or toluenesulfoneamide (Santicizer 8 monsanto) can also be included in the amorphous polyamide. For most applications, a glass transition temperature Tg (measured in a dried state, i.e., with a water content of about 0.12 wt % or less) of amorphous polyamide is about 70-170° C., and preferably about 80-160° C. The amorphous polyamide, which is not blended, has a Tg of approximately 125° C. in a dried state. The lower limit of Tg is not clear, but 70° C. is an approximate lower limit. The upper limit of Tg is not clear, too. However, when polyamide with a Tg of about 170° C. or greater is used, thermal molding is difficult. Therefore, polyamide having both an acid and an amine having aromatic groups cannot be thermally molded due to too high Tg, and thus, is not suitable for the purposes of the present invention.

The polyamide may also be a semicrystalline polyamide. The semicrystalline polyamide is generally prepared using lactam, such as nylon 6 or nylon 11, or an amino acid, or is prepared by condensing diamine, such as hexamethylenediamine, with dibasic acid, such as succinic acid, adipic acid, or sebacic acid. The polyamide may be a copolymer or a terpolymer such as a copolymer of hexamethylenediamine/adipic acid and caprolactame (nylon 6, 66). A mixture of two or more crystalline polyamides can also be used. The semicrystalline and amorphous polyamides are prepared by condensation polymerization well-known in the art.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 1 to 95 parts by weight, and more preferably 1 to 30 parts by weight in the nanocomposite composition. If the content of the nanocomposite is less than 1 part by weight, an improvement of barrier properties is negligible. If the content of the nanocomposite is greater than 95 parts by weight, processing is difficult.

The polyolefin resin may include at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

The content of the polyolefin resin is preferably 1 to 97 parts by weight, and more preferably 20 to 97 parts by weight. If the content of the polyolefin resin is less than 1 part by weight, molding is difficult. If the content of the polyolefin resin is greater than 97 parts by weight, the barrier property is poor.

The compatibilizer improves the compatibility of the polyolefin resin and the nanocomposite to form a molded article with a stable structure.

The compatibilizer may be a hydrocarbon polymer having polar groups. When a hydrocarbon polymer having polar groups is used, the hydrocarbon polymer portion increases the affinity of the compatibilizer to the polyolefin resin and to the nanocomposite, thereby obtaining a molded article with a stable structure.

The compatibilizer can include at least one compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, or a modification thereof.

The content of the compatibilizer in the nanocomposite composition is preferably 1 to 95 parts by weight, and more preferably 1 to 30 parts by weight. If the content of the compatibilizer is less than 1 part by weight, the mechanical properties of a molded article from the composition are poor. If the content of the compatibilizer is greater than 95 parts by weight, the molding of the composition is difficult.

When an epoxy-modified polystyrene copolymer is used as the compatibilizer, a copolymer comprising a backbone which comprises 70 to 99 parts by weight of styrene and 1 to 30 part by weight of an epoxy compound represented by Formula 1, and branches which comprise 1 to 80 parts by weight of acrylic monomers represented by Formula 2, is preferable. The content of the epoxy-modified polystyrene copolymer is preferably 1 to 80 parts by weight based on 100 parts by weight of the nanocomposite composition. If the content of the epoxy-modified polystyrene copolymer is less than 1 part by weight, the mechanical properties of a molded article from the composition are poor. If the content of the epoxy-modified polystyrene copolymer is greater than 80 parts by weight, the molding of the composition is difficult. 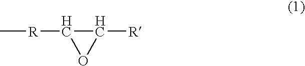
where each of R and R′ is independently a C₁-C₂₀ aliphatic residue or a C₅-C₂₀ aromatic residue having double bonds at its termini

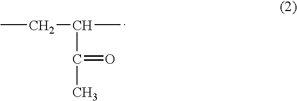

Each of the maleic anhydride modified (graft) high-density polyethylene, maleic anhydride modified (graft) linear low-density polyethylene, and maleic anhydride modified (graft) ethylene-vinyl acetate copolymer preferably comprises branches having 0.1 to 10 parts by weight of maleic anhydride based on 100 parts by weight of the backbone. When the content of the maleic anhydride is less than 0.1 part by weight, it does not function as the compatibilizer. When the content of the maleic anhydride is greater than 10 parts by weight, it is not preferable due to an unpleasant odor.

The nanocomposite composition of the present invention is prepared by dry-blending the nanocomposite having barrier properties in a pellet form, the compatibilizer and the polyolefin resin at a constant compositional ratio in a pellet mixer.

Then, the prepared nanocomposite composition is molten-blended in an extruder to form a pellet maintaining barrier properties. When the pellet maintaining barrier properties is formed, the extrusion temperature and the L/D ratio of the extruder are particularly important. The extrusion temperature is generally 160 to 270° C., and may vary according to the type of resin. For example, the extrusion temperature is 190 to 210° C. for ethylenevinylalcohol and 240 to 265° C. for polyamide. When the extrusion temperature is less than 160° C., processing is difficult due to overload of the extruder. When the extrusion temperature is greater than 270° C., physical properties of the pellet is reduced, which is not preferable.

The L/D ratio of the extruder is preferably 15 or less, and more preferably 10 or less. When the L/D ratio is greater than 15, it is difficult to maintain barrier morphology of the nanocomposite due to excessive molten-blending.

The pelletized nanocomposite is molded to prepare a tube shoulder having barrier properties.

The tube shoulder may be molded by a general molding method including extrusion molding, pressure molding and injection molding.

The prepared tube shoulder is bonded to a separately prepared tube body to complete a tube container.

The tube body can be generally molded using a 5-layered structure of LDPE/adhesive/EVOH/adhesive/LDPE having good barrier properties and can also be prepared using other materials having good barrier properties.

The bonding method includes, is not limited to, extruding or injecting to the tube body.

Hereinafter, the present invention is described in more detail through examples. The following examples are meant only to increase understanding of the present invention, and are not meant to limit the scope of the invention.

### EXAMPLES

In the following examples, a tube shoulder was prepared according to the method of the present invention and was compared with a conventional tube shoulder in terms of barrier properties and adhesion to a tube body.

The materials used in the following examples are as follows:
EVOH: E105B (Kuraray, Japan)
Nylon 6: EN 500 (KP Chemicals)
HDPE-g-MAH: Compatibilizer, PB3009 (CRAMPTON)
HDPE: ME6000 (LG CHEM)
Clay: Closite 30B (SCP)
Thermal stabilizer: IR 1098 (Songwon Inc.)

### Preparation Example 1

(Preparation of EVOH/Intercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; φ40). Then, 3.0 wt % of organic montmorillonite (Southern Intercalated Clay Products, USA; C2OA) as an intercalated clay and 0.1 part by weight of IR 1098 as a thermal stabilizer based on 100 parts by weight of the EVOH and the intercalated clay were separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 15 kg/hr.

Preparation Example 2

(Preparation of Nylon 6/Intercalated Clay Nanocomposite)

97 wt % of a polyamide (nylon 6) was put in the main hopper of a twin screw extruder (SM Platek co-rotation twin screw extruder; φ40). Then, 3 wt % of organic montmorillonite as an intercalated clay and 0.1 part by weight of IR 1098 as a thermal stabilizer based on 100 parts by weight of the EVOH and the intercalated clay were separately put in the side feeder of the twin screw extruder to prepare a polyamide/intercalated clay nanocomposite in a pellet form. The extrusion temperature condition was 220-225-245-245-245-245-245° C., the screws were rotated at 300 rpm, and the discharge condition was 40 kg/hr.

### Example 1

30 parts by weight of the EVOH/intercalated clay nanocomposite obtained in the Preparation Example 1, 4 parts by weight of a compatibilizer, and 66 parts by weight of HDPE were dry-blended and put in the main hopper of a single-screw extruder (Goetffert φ45, L/D: 23). Under an extrusion temperature condition of 190-210-210-210-210° C., the molten-blending process was performed to prepare a pellet. The screw was rotated at 20 rpm, and the discharge condition was 6 kg/hr.

The pellet was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

### Example 2

30 parts by weight of the Nylon 6/intercalated clay nanocomposite obtained in the Preparation Example 2, 4 parts by weight of a compatibilizer, and 66 parts by weight of HDPE were dry-blended and put in the main hopper of a single-screw extruder (Goetffert φ45, L/D: 23). Under an extrusion temperature condition of 240-265-265-265° C., the molten-blending process was performed to prepare a pellet. The screw was rotated at 20 rpm, and the discharge condition was 5 kg/hr.

The pellet was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

### Example 3

50 parts by weight of the EVOH/intercalated clay nanocomposite obtained in the Preparation Example 1, 20 parts by weight of a compatibilizer, and 30 parts by weight of HDPE were dry-blended and put in the main hopper of a single-screw extruder (Goetffert φ45, L/D: 23). Under an extrusion temperature condition of 190-210-210-210-210° C., the molten-blending process was performed to prepare a pellet. The screw was rotated at 20 rpm, and the discharge condition was 6 kg/hr.

The pellet was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

### Example 4

50 parts by weight of the Nylon 6/intercalated clay nanocomposite obtained in the Preparation Example 2, 20 parts by weight of a compatibilizer, and 30 parts by weight of HDPE were dry-blended and put in the main hopper of a single-screw extruder (Goetffert φ45, L/D: 23). Under an extrusion temperature condition of 240-265-265-265° C., the molten-blending process was performed to prepare a pellet. The screw was rotated at 20 rpm, and the discharge condition was 5 kg/hr.

The pellet was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

### Example 5

5 parts by weight of the EVOH/intercalated clay nanocomposite obtained in the Preparation Example 1, 2 parts by weight of a compatibilizer, and 93 parts by weight of HDPE were dry-blended and put in the main hopper of a single-screw extruder (Goetffert φ45, L/D: 23). Under an extrusion temperature condition of 190-210-210-210-210° C., the molten-blending process was performed to prepare a pellet. The screw was rotated at 20 rpm, and the discharge condition was 6 kg/hr.

The pellet was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

### Example 6

5 parts by weight of the Nylon 6/intercalated clay nanocomposite obtained in the Preparation Example 2, 2 parts by weight of a compatibilizer, and 93 parts by weight of HDPE were dry-blended and put in the main hopper of a single-screw extruder (Goetffert φ45, L/D: 23). Under an extrusion temperature condition of 240-265-265-265° C., the molten-blending process was performed to prepare a pellet. The screw was rotated at 20 rpm, and the discharge condition was 5 kg/hr.

The pellet was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

### Comparative Example 1

HDPE was extruded into a tube shoulder using a shoulder extruder (LG Chem., L/D: 10) under an extrusion temperature condition of 240-265-265-265° C. and simultaneously bonded to a tube body molded into a 5-layer LDPE/adhesive (admer)/EVOH/adhesive (admer)/LDPE (190/35/50/35/190) structure on a shoulder mold.

For the tube shoulders prepared in Examples 1 to 6 and Comparative Example 1, tensile strength of the tube body/shoulder bonding portion and a barrier property of the tube-type containers were tested. The obtained results are indicated in Tables 1 and 2.

Tensile Strength

The tube body/shoulder bonding portions of tube-type containers prepared in Examples 1 to 6 and Comparative Example 1 were cut to a width of 15 mm such that when they were stretched in a vertical direction, the angle between the tube body and the tube shoulder was equal to 90 degrees. Then, both ends were fixed to a tensile tester (Z020; Zwick) and stretched at a rate of 100 mm/min to measure the tensile strength.

Barrier Property

A lotion (LacVert lotion, LG Household & Health Care) and a sun cream (UV Screen EN1, LG Household & Health Care) were filled in the tube-type containers prepared in Examples 1 to 6 and Comparative Example 1. Then, the containers were weighed and let alone in a dry oven at 50° C. for 15 days. Subsequently, the weight of the containers was measured and a weight loss rate was investigated.

TABLE 1

| | Tensile strength (kg/cm²) |
|---|---|
| Example 1 | 7.25 |
| Example 2 | 9.27 |
| Example 3 | 6.94 |
| Example 4 | 7.39 |
| Example 5 | 8.48 |
| Example 6 | 9.84 |
| Comparative Example 1 | 9.76 |

TABLE 2

Weight loss rate (%)

| | Lotion | Sun cream |
|---|---|---|
| Example 1 | 0.007 | 0.010 |
| Example 2 | 0.005 | 0.008 |
| Example 3 | 0.003 | 0.007 |
| Example 4 | 0.004 | 0.005 |
| Example 5 | 0.018 | 0.020 |
| Example 6 | 0.014 | 0.018 |
| Comparative Example 1 | 0.076 | 0.143 |

As shown in Tables 1 and 2, tube-type containers of Examples 1 to 6 have superior barrier property and adhesion to the tube body compared to those of Comparative Example 1.

The tube shoulder prepared according to the method of the present invention can effectively prevent the inflow of oxygen and prepare a tube-type container having a good storage property due to superior barrier properties and adhesion to the tube body.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a tube shoulder having barrier properties, the method comprising:
mixing an intercalated clay and at least one resin having barrier properties, selected from the group consisting of an ethylene-vinyl alcohol (EVOH) copolymer, a polyamide, an ionomer and a polyvinyl alcohol (PVA) to prepare a nanocomposite having barrier properties;
dry-blending the nanocomposite with a polyolefin resin and a compatibilizer to prepare a nanocomposite composition;
molten-blending the nanocomposite composition in an extruder to form a pellet having barrier properties; and
molding the pellet.

2. The method of claim 1, wherein 1 to 95 parts by weight of the nanocomposite is dry-blended with 1 to 97 parts by weight of the polyolefin resin and 1 to 95 parts by weight of the compatibilizer to prepare the nanocomposite composition.

3. The method of claim 1, wherein the molten-blending is performed using an extruder with a L/D ratio of 20 or less at 160 to 270° C. to form the pellet.

4. The method of claim 1, wherein the pellet is molded by blowing molding, extrusion molding, pressure molding or injection molding.

5. The method of claim 1, wherein the weight ratio of the resin having barrier properties to the intercalated clay in the nanocomposite is 58.0:42.0 to 99.9:0.1

6. The method of claim 1, wherein the polyamide is at least one selected from the group consisting of nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.
